(19) United States
(12) Patent Application Publication
(10) Pub. No.: US 2025/0013212 A1
(43) Pub. Date: Jan. 9, 2025

(54) NONLINEAR OPTIMAL CONTROL METHOD

(71) Applicant: KWANGWOON UNIVERSITY INDUSTRY-ACADEMIC COLLABORATION FOUNDATION, Seoul (KR)

(72) Inventor: Yeonsoo KIM, Seoul (KR)

(21) Appl. No.: 18/709,784

(22) PCT Filed: Nov. 9, 2022
(86) PCT No.: PCT/KR2022/017511

§ 371 Date: May 13, 2024

(30) Foreign Application Priority Data
Nov. 17, 2021 (KR) 10-2021-0158500

(51) Int. Cl. G05B 13/04; G05B 13/02

(52) U.S. Cl. CPC G05B 13/042; G05B 13/027

(57) ABSTRACT

A nonlinear optimal control method is provided. The nonlinear optimal control method comprises performing a policy iteration algorithm using a Lyapunov barrier function made by applying a barrier function to a control Lyapunov function and Sontag's formula.

### TECHNICAL FIELD

The present invention relates to a nonlinear optimal control method.

### BACKGROUND ART

Recently, research on reinforcement learning technology that learns optimal policies based on artificial intelligence technology is being actively conducted in the field of computer engineering. In the case of game fields such as AlphaGo, where the algorithm is widely used, there are few concerns about stability, and the application of the algorithm has been mainly focused on optimality. However, in real systems such as chemical plants or robots, stability must be guaranteed before optimality. In the case of existing studies, an attempt was made to ensure stability by introducing an additional actor network in addition to the critic network. However, most of the existing algorithms are limited to designing update rules for actor networks for single-layer neural networks and are difficult to apply to actual systems. In addition, the actual system must be controlled so as not to exceed the constraints, but existing algorithms have limitations in not breaking the constraints.

### DISCLOSURE

### Technical Problem

The present invention provides a nonlinear optimal control method having good performance.

The other objects of the present invention will be clearly understood by reference to the following detailed description and the accompanying drawings.

### Technical Solution

A nonlinear optimal control method according to the embodiments of the present invention comprises performing a policy iteration algorithm using a Lyapunov barrier function made by applying a barrier function to a control Lyapunov function and Sontag's formula.

The policy iteration algorithm learns an optimal controller while finding a control Lyapunov function that has the same level set form as an optimal value function among control Lyapunov functions, and ensures constraints satisfaction and stability during and after the learning using the Sontag's formula.

The barrier function may reach infinity at the boundary of the inequality constraints. The constraints of the optimal value function may be included in an objective function by the barrier function.

The policy iteration algorithm may be the following exact safe policy iteration algorithm.

[Exact safe policy iteration algorithm]
Algorithm 1 Exact Safe Policy Iteration Algorithm

```
1: Set an admissible control as initial control policy ψ₀(x), and set k ← 0.
2: (Policy evaluation) Obtain the solution of the following LE, Vₖ ϵ C¹:
  $H ( \text{?} , {V}_{k} , {ψ}_{k} ) = \frac{\partial {V}_{k}}{\partial \text{?}} ( F ( \text{?} ) + G ( \text{?} ) {ψ}_{k} ( \text{?} ) ) + {q}_{aug} ( \text{?} , {ψ}_{k} ( \text{?} ) ) + {{ψ}_{k} ( \text{?} )}^{T} R {ψ}_{k} ( \text{?} ) = 0 , ∀ \text{?} ∈ \text{?} with {V}_{k} ( 0 ) = 0.$
3: (Policy improvement) Update the control policy as
    ${ψ}_{k + 1} ( \text{?} ) = \{ \begin{matrix}- \frac{{L}_{F} {V}_{k} + \sqrt{\text{?}}}{\text{?}} {R}^{- 1} {L}_{G} {V}_{k}^{T} & {L}_{G} {V}_{k} \neq 0 \\ 0 & {L}_{G} {V}_{k} = 0\end{matrix}$
4: Iterate steps 2 and 3 with k ← k + 1 until ∥Vₖ₊₁ − Vₖ∥_{∞} < ϵ.
$\text{?} \text{indicates text missing or illegible when filed}$
```

The exact safe policy iteration algorithm may solve Lyapunov equation in a policy evaluation part to calculate the control Lyapunov function Vₖ that evaluates whether constraints are violated, and costs incurred under current stabilization control input ψₖ. The exact safe policy iteration algorithm may ensure the constraints satisfaction and stability during and after the learning using the Sontag's formula in a policy improvement part.

The policy iteration algorithm may be the following approximate safe policy iteration algorithm.

[Approximate safe policy iteration algorithm]
Algorithm 2 Proposed Approximate Safe RL

```
(Approximate function initialization)
  1: for i = 1, . . . , [symbol]     do
  2:  Initialize [symbol]    ( [symbol]   ) = N [symbol]   ( [symbol]   ) + LB( [symbol]   ).
  3:  If [symbol]     satisfies the CLF condition on grid points in [symbol]     then break
  4:  else i ← i + 1
  5:  end if
  6: end for
  7: Sontag's formula with the CLF [symbol]    ( [symbol]   ), [symbol]    ( [symbol]   ), is set as the initial controller. Set k ← 0.
  (Training while restricting approximate function as a CLF)
  8: for j = 1, . . . , [symbol]     do
  9:  Reset the extended states of the system [symbol]     that is randomly sampled in IntX. Set l ← 0.
10:  for l = 0, . . . , T_{f} − 1 do
11:  Apply the input [symbol]     = [symbol]     to the system.
12:  Obtain the next states [symbol]    .
13:  Store the data set ( [symbol]   ) to replay buffer.
14:  if The number of replay buffer data ≥ N_{RB} then
15:  Record Wₖ as Wₚᵣₑ. The learning rate [symbol]     is set as a user-specified learning rate [symbol]    .
    Set c ← 0.
16:  for c = 0, . . . , [symbol]     − 1 do
17:  Train the approximate function by the Adam optimizer with minibatch data and [symbol]     to
    minimize,
                ${J}_{E , k} = \frac{1}{{N}_{MB}} \text{?} \frac{1}{2} {{BE}_{k} ( \text{?} )}^{2} .$
  Here, BEₖ( [symbol]   ) = L_{V}\hat{V}ₖ( [symbol]   ) + L_{C}\hat{V}ₖ( [symbol]   )α + q_{aug}( [symbol]   ) + α^{T}Rα, and ( [symbol]   ) are randomly sampled
    data from the replay buffer.
18:  if The updated \hat{V}ₖ₊₁(x; Wₖ₊₁) does not satisfy the CLF condition on grid points in [symbol]
    then
19:  Wₖ ← Wₚᵣₑ
20: [symbol]     ← [symbol]    /10, and c ← c + 1,
21:  else
22:  break.
23:  end if
24:  end for
    (Improve control policy using Sontag's formula)
25: Update the control policy as follows:
        ${ψ}_{k + 2} ( \text{?} ) = \{ \begin{matrix}- \frac{{L}_{F} {V}_{k + 1} + \sqrt{\text{?}}}{\text{?}} {R}^{- 1} {L}_{G} {V}_{k + 1}^{T} & {L}_{G} {\hat{V}}_{k} \neq 0 \\ 0 & {L}_{G} {\hat{V}}_{k} = 0\end{matrix}$
26:  end if
27:  k ← k + 1, l ← l + 1
28:  end for
29: end for [symbol]
indicates data missing or illegible when filed
```

The approximate safe policy iteration algorithm may learn neural network, and the neural network may satisfy the property of the control Lyapunov function.

The approximate safe policy iteration algorithm may gather the states determined by a stabilization control input (\hat{ψ}ₖ) and perform weight update of a value function (\hat{V}ₖ) approximated by a deep neural network in the direction of reducing Bellman errors in a policy evaluation part.

Constraints may be considered through an augmented objective function including the barrier function. The approximate safe policy iteration algorithm may ensure the constraints satisfaction and stability during and after the learning using the Sontag's formula in a policy improvement part.

When the weight updated value function does not satisfy the control Lyapunov function conditions, the weight update may be performed again to satisfy the function conditions.

### Advantageous Effects

The nonlinear optimal control method according to the embodiments of the present invention has good performance. For example, the nonlinear optimal control method can ensure both constraints satisfaction and stability.

### DESCRIPTION OF DRAWINGS

FIG. 1 shows a four-tank configuration for illustrating a nonlinear optimal control method according to an embodiment of the present invention.

FIG. 2 shows the absolute errors between the costs of the trained controller and the model prediction controller.

### BEST MODE

Hereinafter, a detailed description will be given of the present invention with reference to the following embodiments. The purposes, features, and advantages of the present invention will be easily understood through the following embodiments. The present invention is not limited to such embodiments, but may be modified in other forms. The embodiments to be described below are nothing but the ones provided to bring the disclosure of the present invention to perfection and assist those skilled in the art to completely understand the present invention. Therefore, the following embodiments are not to be construed as limiting the present invention.

The terminology used herein is for the purpose of describing particular embodiments only and is not intended to limit the invention. It is to be understood that the singular forms “a,” “an,” and “the” include plural references unless the context clearly dictates otherwise. It will be further understood that the terms “comprises” or “has,” when used in this specification, specify the presence of stated features, integers, steps, operations, elements, and/or components, but do not preclude the presence or addition of one or more other features, integers, steps, operations, elements, components, and/or groups thereof.

A nonlinear optimal control method according to the embodiments of the present invention comprises performing a policy iteration algorithm using a Lyapunov barrier function made by applying a barrier function to a control Lyapunov function and Sontag's formula.

The policy iteration algorithm learns an optimal controller while finding a control Lyapunov function that has the same level set form as an optimal value function among control Lyapunov functions, and ensures constraints satisfaction and stability during and after the learning using the Sontag's formula.

### [Barrier Function]

A barrier function (BF) is generally used in optimization solvers based on interior-point methods. The barrier function is used to consider inequality constraints into the objective function, resulting in that the inequality constrained optimization problem is converted into the equality constrained optimization problem. The barrier function reaches infinity at the boundary of the inequality constraints set and the optimization solver finds the optimal solution minimizing the sum of the original objective function and the barrier function. Thus, the optimization solver can find the solution within the feasible region.

The natural extension of the barrier function to the system with control inputs is control barrier function (CBF). To clarify the control barrier function, the control barrier function is explained with mathematical descriptions. The control barrier function is defined by the extended states x̅.

### Definition 1: Control Barrier Function

A C function BF(x̅): Intχ×IntU→ [symbol] is a control barrier function (CBF) for the dynamic system with the set χ×U. If there exist class [symbol] functions α₁, α₂, and α₃, the following inequality follows:

$$\frac{1}{{α}_{1} ( h ( \overline{x} ) )} \leq BF ( \overline{x} ) \leq \frac{1}{{α}_{2} ( h ( \overline{x} ) )} \qquad [ Inequation 1 ]$$

$$\frac{dBF ( \overline{x} )}{dt} \leq {α}_{3} ( h ( \overline{x} ) ) ∀ \overline{x} ∈ Int 𝒳 \times Int 𝒰 \qquad [ Inequation 2 ]$$

The Lyapunov-like condition (Inequation 1) implies that BF(x̅) behaves like

$$\frac{1}{α ( h ( \overline{x} ) )}$$

with some class [symbol] function α:

$${inf}_{x ∈ Int ( 𝒳 )} \frac{1}{α ( h ( \overline{x} ) )} \geq 0 , {lim}_{\text{?}} \frac{1}{α ( h ( \overline{x} ) )} = ∞ .$$

$$\text{?} \text{indicates text missing or illegible when filed}$$

This means that BF(x̅) satisfies the important properties of the barrier function:

$${inf}_{x ∈ Int ( 𝒳 )} BF ( \overline{x} ) \geq 0 , {lim}_{\overline{x} \to \partial \overline{𝒳}} BF ( \overline{x} ) = ∞$$

Inequation 2 guarantees the forward control invariance of Intχ̅ with respect to the dynamics. This is the relaxation of the original condition of

$$\frac{dBF}{dt} \leq 0.$$

$$\frac{dBF}{dt} \leq 0$$

makes BF(x̅) decrease or keep constant along with the dynamics. That is, the state x̅ stay in the interior. The related condition (Inequation 2) allows for an increase in BF(x̅) when the states are far away from the constrain boundary. Even under this GC relaxed condition,

$$BF ( \overline{x} ( t ) ) \leq \frac{1}{σ ( \frac{1}{BF ( \text{?} )} , t - {t}_{0} )}$$

$$\text{?} \text{indicates text missing or illegible when filed}$$

holds for all t and x̅(t₀)∈Intχ̅ when x̅(t) has a unique solution for all t. The lower bound of inequation 1,

$$h ( \overline{x} ( t ) ) \geq {α}_{1}^{- 1} ( σ ( \frac{1}{BF ( \text{?} )} , t - {t}_{0} )$$

$$\text{?} \text{indicates text missing or illegible when filed}$$

holds for all t. This implies that h(x̅(t))>0 holds for all x̅(t₀)∈Intχ̅.

$$BF ( x ) = - log ( \frac{h ( \overline{x} )}{1 + h ( \overline{x} )} )$$

can be a control barrier function candidate with appropriate control inputs.

The control input should be designed such that the allowed increasing speed of the control barrier function value decreases near the boundary and approaches zero as the states go to the boundary. This relaxed property will be made stricter to guarantee that the control barrier function value decreases at least near the boundary in the proposed algorithm.

This is because in real applications, the data are obtained only at sampling times with a finite interval. To guarantee safety, that is, the forward control invariance under this real situation, the control barrier function value along with dynamics should decrease at least near the boundary.

### [Control Lyapunov Function and Sontag's Formula]

The control Lyapunov function is and extension of the Lyapunov function for stabilization. The definition is described as follows.

### Definition 2: Control Lyapunov Function

V_{c}(x̅) is the control Lyapunov function when it is a positive definite, proper, and continuous differential function satisfying the following property.

$$for all \overline{x} \neq 0 of {L}_{G} {V}_{c} ( \overline{x} ) = 0 , {L}_{F} {V}_{c} ( \overline{x} ) < 0$$

L_{G}V_{c} and L_{F}V_{c} denote

$$\frac{\partial {V}_{c}}{\text{?}} G$$

$$\text{?} \text{indicates text missing or illegible when filed}$$

and

$$\frac{\partial {V}_{c}}{\text{?}} F ,$$

$$\text{?} \text{indicates text missing or illegible when filed}$$

respectively. When the property holds globally and V_{c}(x̅) is radially unbounded, then V_{c} is the global control Lyapunov function.

The control inputs with Sontag's formula using control Lyapunov function are as follows.

$${ψ}_{c} ( \overline{x} ) = \{ \begin{matrix}- \frac{{L}_{F} {V}_{c} + \sqrt{{L}_{F} {V}_{c}^{2} + {( {L}_{G} {V}_{c} {L}_{G} {V}_{c}^{⊤} )}^{2}}}{{L}_{G} {V}_{c} {L}_{G} {V}_{c}^{⊤}} {L}_{G} {V}_{c}^{⊤} & {L}_{G} {V}_{c} \neq 0 \\ 0 & {L}_{G} {V}_{c} = 0\end{matrix}$$

Sontag's formula input provides an asymptotic stabilizing controller because of the control Lyapunov function property. Considering the converse Lyapunov theorem and Sontag's formula, the existence of a control Lyapunov function is equivalent to the existence of a smooth controller stabilizing the system asymptotically.

As a significant property of Sontag's formula, is equivalent to the optimal controller for a user-defined cost function r(x̅, a)=q(x̅)+a^{T}Ra when the CLF has the same level set shapes as those of the optimal value function V*.

$${ψ}_{c} ( \overline{x} ) = \{ \begin{matrix}- \frac{{L}_{F} {V}_{c} + \sqrt{{{L}_{F} {V}_{c}^{2} + q ( \overline{x} ) {L}_{G} {V}_{c} {R}^{- 1} {L}_{G} {V}_{c}^{⊤} )}^{2}}}{{L}_{G} {V}_{c} {L}_{G} {V}_{c}^{⊤}} {R}^{- 1} {L}_{G} {V}_{c}^{⊤} & {L}_{G} {V}_{c} \neq 0 \\ 0 & {L}_{G} {V}_{c} = 0\end{matrix}$$

In other words, ψ(x̅) is equivalent to the optimal controller a*(x̅) when V_{c}=α_{c}(V*) with a differentiable class [symbol] function α_{c}. This holds because V* is the solution to the HJB (Hamilton-Jacobi-Bellman) equation.

$${L}_{F} {V}^{*} ( \overline{x} ) - \frac{1}{4} {L}_{G} {V}^{*} {R}^{- 1} {L}_{G} {V}^{* T} + q ( \overline{x} ) = 0 \\ \frac{\partial {V}_{c}}{\partial \overline{x}} = \frac{\partial {α}_{c} ( {V}^{*} )}{\partial {V}^{*}} \frac{\partial {V}^{*}}{\partial \overline{x}} = λ ( \overline{x} ) \frac{\partial {V}^{*}}{\partial \overline{x}} with λ ( \overline{x} ) > 0 for all \neq 0. \\ For {L}_{G} V \neq 0 , \\ - \frac{{L}_{F} {V}_{c} + \sqrt{{L}_{F} {V}_{c}^{2} + q ( \overline{x} ) {L}_{G} {V}_{c} {R}^{- 1} {L}_{G} {V}_{c}^{T}}}{{L}_{G} {V}_{c} {R}^{- 1} {L}_{G} {V}_{c}^{T}} {R}^{- 1} {L}_{G} {V}_{c}^{T} = \\ - \frac{{L}_{F} {V}^{*} + \sqrt{{L}_{F} {V}^{* 2} + q ( \overline{x} ) {L}_{G} {V}^{*} {R}^{- 1} {L}_{G} {V}^{* T}}}{{L}_{G} {V}^{*} {R}^{- 1} {L}_{G} {V}^{* T}} {R}^{- 1} {L}_{G} {V}^{* T} = \\ - \frac{{L}_{F} {V}^{*} + \sqrt{{( q ( \overline{x} ) + \frac{1}{4} {L}_{G} {V}^{*} {R}^{- 1} {L}_{G} {V}^{* T} )}^{2}}}{{L}_{G} {V}^{*} {R}^{- 1} {L}_{G} {V}^{* T}} {R}^{- 1} {L}_{G} {V}^{* T} = \\ - \frac{1}{2} {R}^{- 1} {L}_{G} {V}^{* T}$$

The first equality is because

$$\frac{\partial {V}_{c}}{\partial \overline{x}} = λ ( \overline{x} ) \frac{\partial {V}^{*}}{\partial \overline{x}}$$

with a positive scalar function λ(x̅). The second and third equalities are due to the HJB equation. For L_{G}V_{c}=0, both and are 0.

The similarity of the level-set shapes between two scalar functions can be represented by calculating the standard deviation of the element-wise division of their gradient vectors. If we precisely know the optimal value function, this measure can be used to demonstrate the similarity degree of the trained control Lyapunov function and the optimal value function. However, determining the optimal value function is difficult, which is why reinforcement learning (RL) is used to learn the optimal control policy along with the optimal value function.

When considering the above equation, the similarity of the level set shapes can be practically checked by comparing Sontag's formula input with the optimal formula input.

The simulation results are analyzed by investigating how much similar the Sontag's formula inputs are with the optimal formula inputs

$$- \frac{1}{2} {R}^{- 1} {L}_{G} {V}^{*} .$$

For simplification, the optimal formula is called an LgV-type formula.

### [Lyapunov Neural Network]

The necessary conditions for the control Lyapunov function are positive definiteness and continuous differentiability. Thus, it is needed to guarantee that the approximate function has these properties for any parameter values. For this, the Lyapunov neural network (LNN) is used.

The Lyapunov neural network \hat{V}(x̅) is obtained by the inner product of a feedforward neural network ϕ(x̅) with itself, that is, \hat{V}(x̅)=ϕ(x̅)^{T}ϕ(x̅). ϕ(x̅) with a finite number of parameters can approximate any continuous function on a compact set with arbitrary accuracy. Owing to the inner product, the positiveness of \hat{V}(x̅) is guaranteed. To ensure that \hat{V}(x̅) has a zero value only at x̅=0, the null space of ϕ(x̅) should be trivial. To this end, each layer of ϕ(x̅) must have a trivial null space. This can be obtained with the specific structure of the below equation for A_{L}, when the output of layer L is represented as y_{L}=α(A_{L}y_{L-1}) with a weight matrix A_{L} and an activation function α(⋅).

$${A}_{L} = [ \begin{matrix}{G}_{{L}_{1}}^{T} {G}_{L 1} + ϵ {I}_{{d}_{L - 1}} \\ {G}_{L 2}\end{matrix} ]$$

d_{L} is the dimension of the layer L. G_{L1}∈ [symbol] ^{q}^{₁}^{×d}^{_{L-1}} for some integer q_{L}≥1, G_{L2}∈ [symbol] ^{(d}^{_{L}}^{-d}^{_{L-1}}^{)×d}^{_{L-1}}, and ϵ is a positive constant. I_{d}_{_{L-1}} denotes the identity matrix of dimension d_{L-1}. The parameters to train are the elements of G_{L1} and G_{L2} of all layers. \hat{V} is continuously differentiable.

### [Safe Reinforcement Learning for Constrained Nonlinear Systems]

Safe reinforcement learning according to the embodiments of the present invention uses a modified barrier function and Sontag's formula to guarantee constraint satisfaction. The original optimal control problem is modified by introducing a Lyapunov barrier function, LB(x̅) into the objective function.

$${min}_{a} {V}_{aug}^{α} ( \overline{x} ) \\ subject to {\overline{x}}^{\text{?}} ( t ) = F ( \overline{x} ) + G ( \overline{x} ) a , x ( 0 ) = x , u ( 0 ) = u \\ {V}_{aug}^{α} ( \overline{x} ) = {\int }_{t}^{∞} {q}_{aug} ( \overline{x} ( τ ) ) + {a ( τ )}^{T} Ra ( τ ) d τ$$

$$\text{?} \text{indicates text missing or illegible when filed}$$

with q_{aug}(x̅)=q(x̅)+μLB(x̅). μ is set sufficiently small so as not to disturb the optimal performance while providing enough barrier near the boundary.

Before introducing a Lyapunov barrier function, some assumptions for the optimal control problem are necessary.

### Assumption 1: Existence of an Admissible Input

For any initial extended state in Intχ̅, there exists a continuous control policy a(x̅) asymptotically stabilizing the system with a(0)=0 and its cost V_{aug}^{a}(x̅) is finite.

This assumption implies that the optimal control problem is feasible for the domain Intχ̅. If there is no admissible control policy, there is no hope of obtaining a possible control policy to keep the system in a safe region.

### Assumption 2: Lyapunov Barrier Function

LB(x̅) is a continuously differentiable function that satisfies the following properties with class [symbol] functions α₁ and α₂.

$$\frac{1}{{α}_{1} ( h ( \overline{x} ) )} \leq LB ( \overline{x} ) \leq \frac{1}{{α}_{2} ( h ( \overline{x} ) )} ∀ \overline{x} ∈ \overline{χ} \\ LB ( \overline{x} ) = 0 if and only if \overline{x} = 0$$

Lyapunov barrier function must satisfy additional property, LB(x̅)=0 if and only if x̅=0, along with the general barrier function properties. Without this, the objective function would have an infinite value. Thus, Assumption 2 cannot hold without the positive definiteness of the Lyapunov barrier function. q_{aug}(x̅) is still positive definite with LB(x̅). The condition of the time derivative of the control barrier function will be obtained using Sontag's formula, thus, it is not needed to assume the property here.

Assumption 3 There is a positive definite and continuously differentiable function V*: Intχ̅→ [symbol] , which is the solution of the HJB equation with the augmented objective function.

$${min}_{a} \{ \frac{\partial {V}^{*}}{\partial \overline{x}} ( F ( \overline{x} ) + G ( \overline{x} ) a ) + {q}_{aug} ( \overline{x} ) + {a}^{T} Ra \} = \frac{\partial {V}^{*}}{\partial \overline{x}} ( F ( \overline{x} ) + G ( \overline{x} ) {a}^{*} ) + {q}_{aug} ( \overline{x} ) + {a}^{* T} {Ra}^{*} = \frac{\partial {V}^{*}}{\partial \overline{x}} F ( \overline{x} ) - \frac{1}{4} \frac{\partial {V}^{*}}{\partial \overline{x}} G ( \overline{x} ) {R}^{- 1} G {( \overline{x} )}^{T} \frac{\partial {V}^{* T}}{\partial \overline{x}} + {q}_{aug} ( \overline{x} ) = 0 , for all \overline{x} ∈ Int \overline{χ}$$

Similar to the HJB equation of the original optimal control problem, the above equation has a unique solution when V*(x̅) is continuously differentiable. In addition, if the value function V^{a}^{ₕ}(x̅)=∫ₜ^{∞}q_{aug}(x̅(τ))+aₕ(x̅(τ))^{T}Raₕ(x̅(τ))dτ is continuously differentiable, it satisfies the following Lyapunov equation.

$$\frac{\partial {V}^{{a}_{h}}}{\partial \overline{x}} ( F ( \overline{x} ) + G ( \overline{x} ) {a}_{h} ( \overline{x} ) ) + {q}_{aug} ( \overline{x} ) + {{a}_{h} ( \overline{x} )}^{T} {Ra}_{h} ( \overline{x} ) = 0 with {V}^{{a}_{h}} ( 0 ) = 0$$

If the system is stable and q_{aug}(x̅)+a(x̅)^{T}Ra(x̅) is zero-state observable, the solutions of HJB and Lyapunov equation are positive definite. The sufficient condition for q_{aug}+a^{T}Ra to be zero-state observable is the zero-state observability of the original objective r(x̅, a)=q(x̅)+a^{T}Ra. The general objective function for the stabilization of the tracking problem is zero-state observable because no solution can stay in S={x̅∥r(x̅, 0)=0} other than x̅≡0. For the augmented objective function r(x̅,a)=+LB(x̅) with the original objective function, only x̅≡0 can stay in S_{aug}={x̅|r(x̅, 0)+LB(x̅)=0} owing to the positive definiteness of LB(x̅).

With Assumptions 1-3, there exists a unique optimal control policy that guarantees safety and stabilization. Under the assumptions, the exact policy iteration algorithm with Lyapunov barrier function in Algorithm 1 guarantees the convergences to the optimal value function and optimal control policy. This can be proven easily, as in the original policy iteration proof with q_{aug} instead of q.

Algorithm 1 Exact Safe Policy Iteration Algorithm

```
1: Set an admissible control as initial control policy ψ₀(x), and set k ← 0.
2: (Policy evaluation) Obtain the solution of the following LE, Vₖ ϵ C¹:
  $H ( \text{?} , {V}_{k} , {ψ}_{k} ) = \frac{\partial {V}_{k}}{\partial \text{?}} ( F ( \text{?} ) + G ( \text{?} ) {ψ}_{k} ( \text{?} ) ) + {q}_{aug} ( \text{?} , {ψ}_{k} ( \text{?} ) ) + {ψ}_{k} ( {\text{?}}^{T} R {ψ}_{k} ( \text{?} ) = 0 , ∀ \text{?} ∈ \text{?} with {V}_{k} ( 0 ) = 0.$
3: (Policy improvement) Update the control policy as
    ${ψ}_{k + 1} ( \text{?} ) = \{ \begin{matrix}- \frac{{L}_{F} {V}_{k} + \sqrt{\text{?}}}{\text{?}} {R}^{- 1} {L}_{G} {V}_{k}^{T} & {L}_{G} {V}_{k} \neq 0 \\ 0 & {L}_{G} {V}_{k} = 0\end{matrix}$
4: Iterate steps 2 and 3 with k ← k + 1 until ∥Vₖ₊₁ − Vₖ∥_{∞} < ϵ.
$\text{?} \text{indicates text missing or illegible when filed}$
```

Solving Lyapunov equation for nonlinear systems is difficult, thus, approximate policy iteration is used with approximate functions such as deep neural networks and up-to-date gradient-based optimization solvers such as the Adam optimizer. The approximate function \hat{V}ₖ is not the exact solution of Lyapunov equation and causes deviations, the Bellman error: BE(x̅; Ŵₖ).

$$BE ( \overline{x} , {{W}_{k}}^{\text{?}} ) = H ( \overline{x} , {{V}_{k}}^{\text{?}} , {π}_{k} ) = \frac{\partial {\hat{V}}_{k}}{\partial \overline{x}} ( F ( \overline{x} ) + G ( \overline{x} ) {π}_{k} ( \overline{x} ) ) + {q}_{aug} ( \overline{x} , {π}_{k} ( \overline{x} ) ) + {{π}_{k} ( \overline{x} )}^{T} R {π}_{k} ( \overline{x} )$$

$$\text{?} \text{indicates text missing or illegible when filed}$$

Ŵ denotes the parameters of the approximate function. Because of the approximation errors, stability is not guaranteed during the training if the performance-oriented control formula is used. This can be addressed with the approximate function restricted to the control Lyapunov function and using the stability-oriented formula, Sontag's formula. Safety can be guaranteed by introducing the Lyapunov barrier function. The approximate safe reinforced learning with Lyapunov barrier function, control Lyapunov function, and Sontag's formula is proposed in Algorithm 2. The approximate function \hat{V}ₖ should have the Lyapunov barrier function property for constraint satisfaction. In addition, the optimal value function also has large values near the boundary when considering the augmented objective function. Thus, the sum of the Lyapunov neural network and Lyapunov barrier function is used as the approximate function as follows.

$${\hat{V}}_{k} ( \overline{x} ) = N {N}_{k} ( \overline{x} ) + LB ( \overline{x} )$$

The form of \hat{V}ₖ is the key factor along with control Lyapunov function condition and Sontag's formula when guaranteeing the forward invariance and the practically asymptotic stability of the system.

Algorithm 2 Proposed Approximate Safe RL

```
(Approximate function initialization)
  1: for i = 1, . . . , [symbol]     do
  2:  Initialize [symbol]    ( [symbol]   ) = N [symbol]   ( [symbol]   ) + LB( [symbol]   ).
  3:  If [symbol]     satisfies the CLF condition on grid points in [symbol]     then break
  4:  else i ← i + 1
  5:  end if
  6: end for
  7: Sontag's formula with the CLF [symbol]    ( [symbol]   ), [symbol]    ( [symbol]   ), is set as the initial controller. Set k ← 0.
  (Training while restricting approximate function as a CLF)
  8: for j = 1, . . . , [symbol]     do
  9:   Reset the extended states of the system [symbol]     that is randomly sampled in [symbol]    . Set l ← 0.
10:  for l = 0, . . . , T_{f} − 1 do
11:  Apply the input [symbol]     = [symbol]     to the system.
12:  Obtain the next states [symbol]    .
13:  Store the data set ( [symbol]   ) to replay buffer.
14:  if The number of replay buffer data ≥ N_{RB} then
15:  Record Wₖ as Wₚᵣₑ. The learning rate [symbol]     is set as a user-specified learning rate [symbol]    .
    Set c ← 0.
16:  for c = 0, . . . , [symbol]     − 1 do
17:  Train the approximate function by the Adam optimizer with minibatch data and [symbol]
  to minimize,
                ${J}_{E , k} = \frac{1}{{N}_{MB}} \text{?} \frac{1}{2} {{BE}_{k} ( \text{?} )}^{2} .$
  Here, BEₖ( [symbol]   ) = L_{V}\hat{V}ₖ( [symbol]   ) + L_{C}\hat{V}ₖ( [symbol]   )α + q_{aug}( [symbol]   ) + α^{T}Rα, and ( [symbol]   ) are randomly sampled
  data from the replay buffer.
18:   if The updated \hat{V}ₖ₊₁(x; Wₖ₊₁) does not satisfy the CLF condition on grid points in [symbol]
    then
19:  Wₖ ← Wₚᵣₑ
20: [symbol]     ← [symbol]    /10, and c ← c + 1,
21:  else
22:  break.
23:  end if
24:  end for
    (Improve control policy using Sontag's formula)
25: Update the control policy as follows:
        ${ψ}_{k + 2} ( \text{?} ) = \{ \begin{matrix}- \frac{{L}_{F} {V}_{k + 1} + \sqrt{\text{?}}}{\text{?}} {R}^{- 1} {L}_{G} {\hat{V}}_{k + 1}^{T} & {L}_{G} {\hat{V}}_{k + 1} \neq 0 \\ 0 & {L}_{G} {\hat{V}}_{k + 1} = 0\end{matrix}$
26:  end if
27:  k ← k + 1, l ← l + 1
28:  end for
29: end for [symbol]
indicates data missing or illegible when filed
```

N_{MB} and N_{RB} denote the sizes of the minibatch and replay buffers, respectively. The past data in the replay buffer are removed when the number of stored data exceeds N_{RB}. Nₑ is the total number of episodes with different initial states used for training. T_{f} is the duration of a single episode. The computational load for checking the control Lyapunov function condition on the grid points can increase as the dimension of the system increases, however, it can be addressed with multiple processors because the condition can be checked in parallel.

### [Practically Asymptotic Stability]

The definitions for practically asymptotic stability are introduced by adapting it to the system of the present invention. To this end, a boundary layer Δ_{δ}_{₁}={x̅∈Intχ̅|x̅∈B_{δ}_{₁}(p), ∀ₚ∈θχ̅} is defined with any sufficiently small δ₁>0. The set Dₘ=Intχ̅\Δ_{δ}_{ₓ} is compact, and δₘ can be set as the radius of the largest ball B̅_{δ}_{ₘ} in Dₘ.

Definition 3: Asymptotic Stability with Respect to a Ball

Let δ be a positive number less than δₘ. The system is asymptotically stable with respect to B̅_{δ} on a domain Dₘ if there exists a class [symbol] [symbol] function β.

$$‖ \overline{x} ( t ) ‖ \leq δ + β ( ‖ {\overline{x}}_{0} ‖ , t ) , ∀ {\overline{x}}_{0} ∈ {D}_{m}$$

### Definition 4 Practical Asymptotic Stability

Let P∈ [symbol] ⁿ^{ₚ} be a set of parameters. The system is said to be a practical asymptotic stability on Dₘ if given δ>0 and for any x̅₀∈Dₘ, there exists a P such that the system is asymptotically stable with respect to B̅_{δ} with a parameterized controller a=a(x̅; P).

On Dₘ excluding an arbitrary thin boundary layer from Intχ̅, the practical asymptotic stability of the system is proved under for all ψₖ in k Theorem 1. In other words, during training and at the end of training, the practical asymptotic stability is guaranteed by the algorithm of the present invention.

Suppose that with any δ<δₘ and any δ₁>0, there exists a positive definite and continuously differentiable function that satisfies the control Lyapunov function condition in the domain Dₘ. Then, there exists an N(δ,δ₁) such that if \hat{V}ₖ satisfies the control Lyapunov function condition on N(δ, δ₁) grid points on Dₘ\B_{δ}, then \hat{V}ₖ is a control Lyapunov function on the domain Dₘ.

As the constrained region χ̅ is assumed to be compact, Intχ̅ is precompact. The precompact set Intχ̅ is totally bounded. Thus, for an arbitrary small δ₁, the compact set Dₘ=Intχ̅\Δ_{δ}_{₁} can be set by excluding the arbitrary thin boundary layer from the Intχ̅. Then, there exists an N(δ,δ₁) such that if \hat{V}ₖ satisfies the control Lyapunov function condition on N(δ,δ₁) grid points, then \hat{V}ₖ is a control Lyapunov function on the domain Dₘ.

Theorem 1: Given a constrained set χ̅ defined using a continuously differentiable function, the system is practically asymptotically stable on Dₘ=Intχ̅\Δ_{δ}_{₁} under the controller ψₖ for all k and for an arbitrary small δ₁>0. With the largest, ρₖ, Ω_{ρ}_{ₖ}={x̅|\hat{V}ₖ(x̅)≤ρₖ}⊂Dₘ is the estimate of ROA (region of attraction). Furthermore, as δ₁→0, Ω₉₂ _{ₖ}→Intχ̅.

As proven above, \hat{V}ₖ is a control Lyapunov function on Dₘ\B_{δ}. Thus, L_{F}\hat{V}ₖ+L_{G}\hat{V}ₖ\hat{ψ}ₖ₊₁<0 always holds for all x̅ on Dₘ\B_{δ} a with any given positive δ<δₘ and an arbitrary small δ₁. Accordingly, Ω_{ρk} is the estimate of ROA.

As δ₁ goes to 0, the values of \hat{V}ₖ at ∂Dₘ goes to ∞. Accordingly, the largest estimate of ROA Ω_{ρk} becomes close to Intχ̅ with ρₖ→∞ and the forward invariance is guaranteed on Ωρₖ.

As described above, the exact safe policy iteration algorithm for solving the Lyapunov equation, which learns the optimal controller by learning the optimal value function of the optimal control problem, is as follows.

[Exact safe policy iteration algorithm]
Algorithm 1 Exact Safe Policy Iteration Algorithm

```
1: Set an admissible control as initial control policy ψ₀(x), and set k ← 0.
2: (Policy evaluation) Obtain the solution of the following LE, Vₖ ϵ C¹:
  $H ( \text{?} , {V}_{k} , {ψ}_{k} ) = \frac{\partial {V}_{k}}{\partial \text{?}} ( F ( \text{?} ) + G ( \text{?} ) {ψ}_{k} ( \text{?} ) ) + {q}_{aug} ( \text{?} , {ψ}_{k} ( \text{?} ) ) + {{ψ}_{k} ( \text{?} )}^{T} R {ψ}_{k} ( \text{?} ) = 0 , ∀ \text{?} ∈ \text{?} with {V}_{k} ( 0 ) = 0.$
3: (Policy improvement) Update the control policy as
    ${ψ}_{k + 1} ( \text{?} ) = \{ \begin{matrix}- \frac{{L}_{F} {V}_{k} + \sqrt{\text{?}}}{\text{?}} {R}^{- 1} {L}_{G} {V}_{k}^{T} & {L}_{G} {V}_{k} \neq 0 \\ 0 & {L}_{G} {V}_{k} = 0\end{matrix}$
4: Iterate steps 2 and 3 with k ← k + 1 until ∥Vₖ₊₁ − Vₖ∥_{∞} < ϵ.
$\text{?} \text{indicates text missing or illegible when filed}$
```

The exact safe policy iteration algorithm consists of the following two main elements.

1) The exact safe policy iteration algorithm solves Lyapunov equation in a policy evaluation part to calculate the control Lyapunov function Vₖ that evaluates whether constraints are violated, and costs incurred under current stabilization control input ψₖ. At this time, the constraints are considered through an augmented objective function q_{aug}.

2) The exact safe policy iteration algorithm ensures the constraints satisfaction and stability during and after the learning using the Sontag's formula in a policy improvement part without introducing additional actor networks.

Since Vₖ(x), the solution to the Lyapunov equation, has a fairly large value at x near the boundary, the value function is used by applying the approximation function that can simulate these characteristics to the control Lyapunov function and the controller using Sontag's formula guarantees the constraints satisfaction and stability. On the other hand, in order to stabilize the system and satisfy the constraints by applying the previously used LgV-type optimal formula, additional conditions are needed while the value function satisfies the control Lyapunov function conditions. These facts confirms that using the Sontag's formula is superior in terms of ensuring the constraints satisfaction and stability and the use of a barrier function is essential.

Because it is very difficult to find a solution to the Lyapunov equation, an approximate policy iteration algorithm that trains a neural network is used. Here, the neural network is used that satisfies the control Lyapunov function property, which is the most important in control, and by adding a barrier function to this neural network, it prevents cases from exceeding the boundary (i.e. breaking constraints).

[Approximate safe policy iteration algorithm]
Algorithm 2 Proposed Approximate Safe RL

```
(Approximate function initialization)
  1: for i = 1, . . . , [symbol]     do
  2:  Initialize [symbol]    ( [symbol]   ) = NN₀( [symbol]   ) + LB( [symbol]   ).
  3:  if [symbol]     satisfies the CLF condition on grid points in [symbol]     then break
  4:  else i ← i + 1
  5:  end if
  6: end for
  7: Sontag's formula with the CLF [symbol]    ( [symbol]   ), [symbol]    ( [symbol]   ), is set as the initial controller. Set k ← 0.
  (Training while restricting approximate function as a CLF)
  8: for j = 1, . . . , [symbol]     do
  9:   Reset the extended states of the system [symbol]     that is randomly sampled in [symbol]    . Set l ← 0.
10:  for l = 0, . . . , T_{f} − 1 do
11:  Apply the input [symbol]     = [symbol]     to the system.
12:  Obtain the next states [symbol]    .
13:  Store the data set ( [symbol]   ) to replay buffer.
14:  if The number of replay buffer data ≥ N_{RB} then
15:  Record Wₖ as Wₚᵣₑ. The learning rate [symbol]     is set as a user-specified learning rate [symbol]    .
    Set c ← 0.
16:  for c = 0, . . . , [symbol]     − 1 do
17:  Train the approximate function by the Adam optimizer with minibatch data and [symbol]
  to minimize,
                ${J}_{E , k} = \frac{1}{{N}_{MB}} \text{?} \frac{1}{2} {{BE}_{k} ( \text{?} )}^{2} .$
  Here, BEₖ( [symbol]   ) = L_{V}\hat{V}ₖ( [symbol]   ) + L_{C}\hat{V}ₖ( [symbol]   )α + q_{aug}( [symbol]   ) + α^{T}Rα, and ( [symbol]   ) are randomly
  sampled data from the replay buffer.
18:  if The updated \hat{V}ₖ₊₁(x; Wₖ₊₁) does not satisfy the CLF condition on grid points in [symbol]
  then
19:  Wₖ ← Wₚᵣₑ
20: [symbol]     ← [symbol]    /10, and c ← c + 1,
21:  else
22:  break.
23:  end if
24:  end for
    (Improve control policy using Sontag's formula)
25: Update the control policy as follows:
        ${ψ}_{k + 2} ( \text{?} ) = \{ \begin{matrix}- \frac{{L}_{F} {V}_{k + 1} + \sqrt{\text{?}}}{\text{?}} {R}^{- 1} {L}_{G} {V}_{k + 1}^{T} & {L}_{G} {\hat{V}}_{k + 1} \neq 0 \\ 0 & {L}_{G} {\hat{V}}_{k + 2} = 0\end{matrix}$
26:  end if
27:  k ← k + 1, l ← l + 1
28:  end for
29: end for [symbol]
indicates data missing or illegible when filed
```

The above algorithm finally proposed consists of the following three main elements.

1) The approximate safe policy iteration algorithm gathers the states determined by a stabilization control input \hat{ψ}ₖ and performs weight update of a value function \hat{V}ₖ approximated by a deep neural network in the direction of reducing Bellman errors in a policy evaluation part. At this time, if the updated value function does not satisfy the control Lyapunov function conditions, the weight update is performed again to satisfy the function conditions. The constraints are considered through an augmented objective function q_{aug} including a barrier function.

2) The approximate safe policy iteration algorithm ensures the constraints satisfaction and stability during and after the learning using the Sontag's formula in a policy improvement part without introducing additional actor networks.

3) When using a deep artificial neural network, a function that has the same level set form as the optimal value function is learned, and if the function used in the Sontag's formula has the same level set form as the optimal value function, it is the same as optimal control, so the optimal controller is approximated.

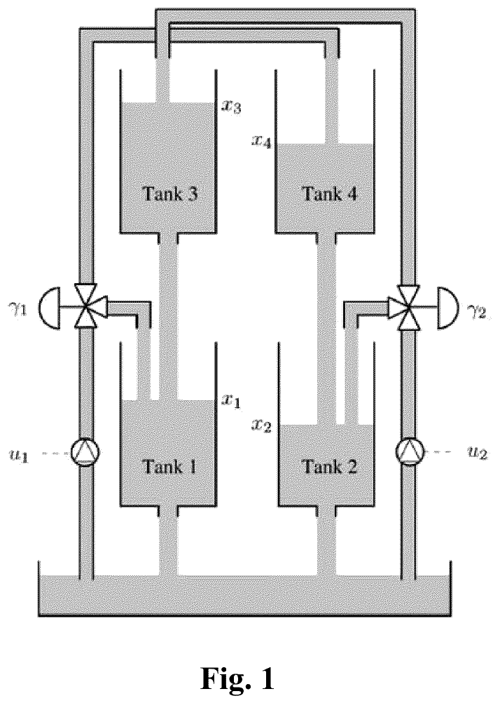

FIG. 1 shows a four-tank configuration for illustrating a nonlinear optimal control method according to an embodiment of the present invention.

Referring to FIG. 1, x₁ denotes the level in each tank i, u₁ and u₂ represent the valve flow rate, and γ₁ and γ₂ represent the valve parameters. The bounds for each tank liquid level and the bounds for u₁ and u₂ corresponding to the manipulated variables are as follows.

| Variable | Lower Bound | Upper bound |
|---|---|---|
| x₁ | 1 | 28 |
| x₂ | 1 | 28 |
| x₃ | 1 | 28 |
| x₄ | 1 | 28 |
| u₁ | 0 | 60 |
| u₂ | 0 | 60 |

Considering the above constraints, and since then stabilization problem is to stabilize to a steady state point (subscript ss), instead of a model equation for xᵢ, a model equation for the deviation (subscript dev) from the setpoint must be used.

In addition, although the model equation is already in a control-affine form, in order to consider the constraints for u through the barrier function, the model equation can be finally expressed as follows.

$$\frac{{dx}_{1 , dev}}{dt} = - \frac{{A}_{out , 1}}{{A}_{1}} \sqrt{2 {gx}_{1}} + \frac{{A}_{out , 3}}{{A}_{1}} \sqrt{2 {gx}_{3}} + \frac{{γ}_{1}}{{A}_{1}} {u}_{1} \\ \frac{{dx}_{2 , dev}}{dt} = - \frac{{A}_{out , 2}}{{A}_{2}} \sqrt{2 {gx}_{2}} + \frac{{A}_{out , 4}}{{A}_{2}} \sqrt{2 {gx}_{4}} + \frac{{γ}_{2}}{{A}_{2}} {u}_{2} \\ \frac{{dx}_{3 , dev}}{dt} = - \frac{{A}_{out , 3}}{{A}_{3}} \sqrt{2 {gx}_{3}} + \frac{1 - {γ}_{2}}{{A}_{3}} {u}_{2} \\ \frac{{dx}_{4 , dev}}{dt} = - \frac{{A}_{out , 4}}{{A}_{4}} \sqrt{2 {gx}_{4}} + \frac{1 - {γ}_{1}}{{A}_{4}} {u}_{1} \\ \frac{{du}_{1 , dev}}{dt} = {a}_{1} \\ \frac{{du}_{2 , dev}}{dt} = {a}_{2} .$$

This can be expressed simply using the F and G notations as follows.

$$\frac{d {\overline{x}}_{dev}}{dt} = {F}_{dev} ( {\overline{x}}_{dev} ) + {F}_{1 , dev} ( {\overline{x}}_{dev} ) {a}_{1} + {G}_{2 , dev} ( {\overline{x}}_{dev} ) {a}_{2}$$

$${F}_{dev} ( {\overline{x}}_{dev} ) = [ \begin{matrix}- \frac{{A}_{out , 1}}{{A}_{1}} \sqrt{2 {gx}_{1}} + \frac{{A}_{out , 3}}{{A}_{1}} \sqrt{2 {gx}_{3}} + \frac{{γ}_{1}}{{A}_{1}} {u}_{1} \\ - \frac{{A}_{out , 2}}{{A}_{2}} \sqrt{2 {gx}_{2}} + \frac{{A}_{out , 4}}{{A}_{2}} \sqrt{2 {gx}_{4}} + \frac{{γ}_{2}}{{A}_{2}} {u}_{2} \\ - \frac{{A}_{out , 3}}{{A}_{3}} \sqrt{2 {gx}_{3}} + \frac{1 - {γ}_{2}}{{A}_{3}} {u}_{2} \\ - \frac{{A}_{out , 4}}{{A}_{4}} \sqrt{2 {gx}_{4}} + \frac{1 - {γ}_{1}}{{A}_{4}} {u}_{1} \\ 0 \\ 0\end{matrix} ] , {G}_{1 , dev} ( {\overline{x}}_{dev} ) = [ \begin{matrix}0 \\ 0 \\ 0 \\ 0 \\ 1 \\ 0\end{matrix} ] , {G}_{2 , dev} ( {\overline{x}}_{dev} ) = [ \begin{matrix}0 \\ 0 \\ 0 \\ 0 \\ 0 \\ 1\end{matrix} ]$$

In neural network learning, if the size difference between variables is large, learning does not work well, so the optimal value function V*(x̅_{dev,n}) with x̅_{dev,n} normalized (divided by upper bound-lower bound) as an argument is learned, at this time, since F and G used in the algorithm must also express dynamics for x̅_{dev,n}, the below equations are used.

$$F = {F}_{dev} \frac{1}{( {\overline{x}}_{ub} - {\overline{x}}_{lb} )} \\ G = [ {G}_{1 , dev} ⌀ \frac{1}{( {\overline{x}}_{ub} - {\overline{x}}_{lb} )} , {G}_{2 , dev} ⌀ \frac{1}{( {\overline{x}}_{ub} - {\overline{x}}_{lb} )} ]$$

In the above equations, [symbol] represents elementary division.

The approximation function \hat{V}ₖ(x̅_{dev,}n) is constructed by adding the barrier function BF(x̅_{dev,n}) to the control Lyapunov function, and in order to be used with the Sontag's formula to stabilize the system to a steady-state point, the barrier function BF(x̅_{dev,n}) must also have positive definite properties.

In other words, the function value must be 0 only in x̅_{dev,n}=0 and the rest must have a value greater than 0. For this, the Lyapunov barrier function LB can be constructed as follows.

$$\begin{matrix}{h}_{1} = {x}_{1 , dev , n} + \frac{{x}_{1 , ss} - {x}_{1 , lb}}{{x}_{1 , ub} - {x}_{1 , lb}} & {h}_{7} = {x}_{4 , dev , n} + \frac{{x}_{4 , ss} - {x}_{4 , lb}}{{x}_{4 , ub} - {x}_{4 , lb}} \\ {h}_{2} = - {x}_{1 , dev , n} + \frac{{x}_{1 , ub} - {x}_{1 , ss}}{{x}_{1 , ub} - {x}_{1 , lb}} & {h}_{8} = - {x}_{4 , dev , n} + \frac{{x}_{4 , ub} - {x}_{4 , ss}}{{x}_{4 , ub} - {x}_{4 , lb}} \\ {h}_{3} = {x}_{2 , dev , n} + \frac{{x}_{2 , ss} - {x}_{2 , lb}}{{x}_{2 , ub} - {x}_{2 , lb}} & {h}_{9} = {u}_{1 , dev , n} + \frac{{u}_{1 , ss} - {u}_{1 , lb}}{{u}_{1 , ub} - {u}_{1 , lb}} \\ {h}_{4} = - {x}_{2 , dev , n} + \frac{{x}_{2 , ub} - {x}_{2 , ss}}{{x}_{2 , ub} - {x}_{2 , lb}} & {h}_{10} = - {u}_{1 , dev , n} + \frac{{u}_{1 , ub} - {u}_{1 , ss}}{{u}_{1 , ub} - {u}_{1 , lb}} \\ {h}_{5} = {x}_{3 , dev , n} + \frac{{x}_{3 , ss} - {x}_{3 , lb}}{{x}_{3 , ub} - {x}_{3 , lb}} & {h}_{11} = {u}_{2 , dev , n} + \frac{{u}_{2 , ss} - {u}_{2 , lb}}{{u}_{2 , ub} - {u}_{2 , lb}} \\ {h}_{6} = - {x}_{3 , dev , n} + \frac{{x}_{3 , ub} - {x}_{3 , ss}}{{x}_{3 , ub} - {x}_{3 , lb}} & {h}_{12} = - {u}_{2 , dev , n} + \frac{{u}_{2 , ub} - {u}_{2 , ss}}{{u}_{2 , ub} - {u}_{2 , lb}}\end{matrix}$$

$${LB}_{1} ( {x}_{1 , dev , n} ) = ( 1 - {s}_{1} ) log ( \frac{{h}_{1}}{{h}_{1} + 1} ) + {s}_{1} log ( \frac{{h}_{2}}{{h}_{2} + 1} ) \\ {LB}_{2} ( {x}_{2 , dev , n} ) = ( 1 - {s}_{2} ) log ( \frac{{h}_{3}}{{h}_{3} + 1} ) + {s}_{2} log ( \frac{{h}_{4}}{{h}_{4} + 1} ) \\ {LB}_{3} ( {x}_{3 , dev , n} ) = ( 1 - {s}_{3} ) log ( \frac{{h}_{5}}{{h}_{5} + 1} ) + {s}_{3} log ( \frac{{h}_{6}}{{h}_{6} + 1} ) \\ {LB}_{4} ( {x}_{4 , dev , n} ) = ( 1 - {s}_{4} ) log ( \frac{{h}_{7}}{{h}_{7} + 1} ) + {s}_{4} log ( \frac{{h}_{8}}{{h}_{8} + 1} ) \\ {LB}_{5} ( {u}_{1 , dev , n} ) = ( 1 - {s}_{5} ) log ( \frac{{h}_{9}}{{h}_{9} + 1} ) + {s}_{5} log ( \frac{{h}_{10}}{{h}_{10} + 1} ) \\ {LB}_{6} ( {u}_{2 , dev , n} ) = ( 1 - {s}_{6} ) log ( \frac{{h}_{11}}{{h}_{11} + 1} ) + {s}_{6} log ( \frac{{h}_{12}}{{h}_{12} + 1} )$$

$$LB ( {\overline{x}}_{dev , n} ) = - μ [ {LB}_{1} ( {x}_{1 , dev , n} ) + {LB}_{2} ( {x}_{2 , dev , n} ) + {LB}_{3} ( {x}_{3 , dev , n} ) + {LB}_{4} ( {x}_{4 , dev , n} ) + {LB}_{5} ( {u}_{1 , dev , n} ) + {LB}_{6} ( {u}_{2 , dev , n} ) - {LB}_{1} ( {x}_{1 , dev , n , ss} ) - {LB}_{2} ( {x}_{2 , dev , n , ss} ) - {LB}_{3} ( {x}_{3 , dev , n , ss} ) - {LB}_{4} ( {x}_{4 , dev , n , ss} ) - {LB}_{5} ( {u}_{1 , dev , n , ss} ) - {LB}_{6} ( {u}_{2 , dev , n , ss} ) ]$$

A neural network to which the LB is added is learned, and the LB is also added to the objective function. Finally, several tuning parameters in the algorithm were set as follows.

| | |
|---|---|
| Nₑ | 100 |
| T_{f} | 150 |
| N_{RB} | 450 |
| N_{MB} | 450 |
| lr₀ | 0.01 |

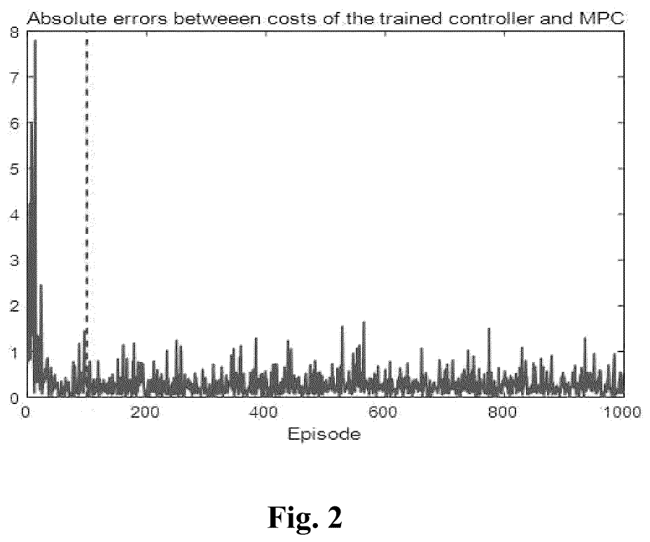

FIG. 2 shows the absolute errors between the costs of the trained controller and the model prediction controller. 1000 episodes were set to start from randomly determined initial conditions within +−50% of the range around the setpoint. Of these, a total of 100 episodes were used for learning, and the performance was tested through the remaining episodes. The cost of the optimal controller was calculated using a model predictive controller with a sufficiently long prediction horizon, and the differences from the corresponding value are shown in FIG. 2.

Referring to FIG. 2, it can be confirmed that a close to optimal controller is learned through the first 100 learning episodes. Additionally, it can be confirmed that there is no episode with infinite cost values. In other words, the algorithm according to the nonlinear optimal control method of the present invention can learn an optimal controller while always satisfying the constraints.

As described above, the present invention provides an important algorithm that enables the application of artificial intelligence technology, which has been developed mainly in computer engineering, to actual systems that require stability. The algorithm utilizes the correlation between the stabilization controller and the optimal controller to ensure constraints satisfaction and stability while learning the optimal controller. The constraints satisfaction is a property that is ensured by utilizing the Sontag equation using a controlled Lyapunov function with a barrier function added. Optimality utilized the fact that the Sontag's formula and the optimal controller are exactly the same when the corresponding control Lyapunov function has the same level set form as the optimal value function. By combining this fact with a policy iteration algorithm that finds the optimal value function, an algorithm was developed to learn the optimal controller while ensuring constraints satisfaction and stability. In order to apply the above algorithm to a real system, when using the essential non-linear deep artificial neural network as an approximation function, and using weight update rules in the direction of reducing standard Bellman error and a critical-network even under the gradient descent algorithm that enables fast learning using accumulated data, it is and standard it is possible to ensure constraints satisfaction and stability. The present invention is a technology needed to expand and apply an artificial intelligence-based optimal control learning algorithm to an actual system.

Although the embodiments of the present invention have been disclosed for illustrative purposes, those skilled in the art will appreciate that the present invention may be embodied in other specific ways without changing the technical spirit or essential features thereof. Therefore, the embodiments disclosed in the present invention are not restrictive but are illustrative. The scope of the present invention is given by the claims, rather than the specification, and also contains all modifications within the meaning and range equivalent to the claims.

### INDUSTRIAL APPLICABILITY

The nonlinear optimal control method according to the embodiments of the present invention has good performance. For example, the nonlinear optimal control method can ensure both constraints satisfaction and stability.

1. A nonlinear optimal control method comprising:
performing a policy iteration algorithm using a Lyapunov barrier function made by applying a barrier function to a control Lyapunov function and Sontag's formula.

2. The nonlinear optimal control method of claim 1, wherein the policy iteration algorithm learns an optimal controller while finding a control Lyapunov function that has the same level set form as an optimal value function among control Lyapunov functions, and ensures constraints satisfaction and stability during and after the learning using the Sontag's formula.

3. The nonlinear optimal control method of claim 2, wherein the barrier function reaches infinity at the boundary of the inequality constraints.

4. The nonlinear optimal control method of claim 2, wherein the constraints of the optimal value function are included in an objective function by the barrier function.

5. The nonlinear optimal control method of claim 1, wherein the policy iteration algorithm is the following exact safe policy iteration algorithm.
[Exact safe policy iteration algorithm]
Algorithm 1 Exact Safe Policy Iteration Algorithm
```
1: Set an admissible control as initial control policy ψ₀(x), and set k ← 0.
2: (Policy evaluation) Obtain the solution of the following LE, Vₖ ϵ C¹:
  $H ( \text{?} , {V}_{k} , {ψ}_{k} ) = \frac{\partial {V}_{k}}{\partial \text{?}} ( F ( \text{?} ) + G ( \text{?} ) {ψ}_{k} ( \text{?} ) ) + {q}_{aug} ( \text{?} , {ψ}_{k} ( \text{?} ) ) + {ψ}_{k} ( {\text{?}}^{T} R {ψ}_{k} ( \text{?} ) = 0 , ∀ \text{?} ∈ \text{?} with {V}_{k} ( 0 ) = 0.$
3: (Policy improvement) Update the control policy as
    ${ψ}_{k + 1} ( \text{?} ) = \{ \begin{matrix}- \frac{{L}_{F} {V}_{k} + \sqrt{\text{?}}}{\text{?}} {R}^{- 1} {L}_{G} {V}_{k}^{T} & {L}_{G} {V}_{k} \neq 0 \\ 0 & {L}_{G} {V}_{k} = 0\end{matrix}$
4: Iterate steps 2 and 3 with k ← k + 1 until ∥Vₖ₊₁ − Vₖ∥_{∞} < ϵ.
$\text{?} \text{indicates text missing or illegible when filed}$
```

6. The nonlinear optimal control method of claim 5, wherein the exact safe policy iteration algorithm solves Lyapunov equation in a policy evaluation part to calculate the control Lyapunov function Vₖ that evaluates whether constraints are violated, and costs incurred under current stabilization control input ψₖ, and
wherein the exact safe policy iteration algorithm ensures the constraints satisfaction and stability during and after the learning using the Sontag's formula in a policy improvement part.

7. The nonlinear optimal control method of claim 1, wherein the policy iteration algorithm is the following approximate safe policy iteration algorithm.
[Approximate safe policy iteration algorithm]
Algorithm 2 Proposed Approximate Safe RL
```
(Approximate function initialization)
  1: for i = 1, . . . , [symbol]     do
  2:  Initialize [symbol]    ( [symbol]   ) = NN₀( [symbol]   ) + LB( [symbol]   ).
  3:  If [symbol]     satisfies the CLF condition on grid points in [symbol]     then break
  4:  else i ← i + 1
  5:  end if
  6: end for
  7: Sontag's formula with the CLF [symbol]    ( [symbol]   ), [symbol]    ( [symbol]   ), is set as the initial controller. Set k ← 0.
  (Training while restricting approximate function as a CLF)
  8: for j = 1, . . . , [symbol]     do
  9:  Reset the extended states of the system [symbol]     that is randomly sampled in [symbol]    . Set l ← 0.
10:  for l = 0, . . . , T_{f} − 1 do
11:  Apply the input [symbol]     = [symbol]     to the system.
12:  Obtain the next states [symbol]    .
13:  Store the data set ( [symbol]   ) to replay buffer.
14:  if The number of replay buffer data ≥ N_{RB} then
15:  Record Wₖ as Wₚᵣₑ. The learning rate [symbol]     is set as a user-specified learning rate [symbol]    .
  Set c ← 0.
16:  for c = 0, . . . , [symbol]     − 1 do
17:  Train the approximate function by the Adam optimizer with minibatch data and [symbol]
  to minimize,
                ${J}_{E , k} = \frac{1}{{N}_{MB}} \text{?} \frac{1}{2} {{BE}_{k} ( \text{?} )}^{2} .$
  Here, BEₖ( [symbol]   ) = L_{V}\hat{V}ₖ( [symbol]   ) + L_{C}\hat{V}ₖ( [symbol]   )α + q_{aug}( [symbol]   ) + α^{T}Rα, and ( [symbol]   ) are randomly sampled
  data from the replay buffer.
18:  if The updated \hat{V}ₖ₊₁( [symbol]    Ŵₖ₊₁) does not satisfy the CLF condition on grid points in [symbol]
  then
19:  Wₖ ← Wₚᵣₑ
20: [symbol]     ← [symbol]    /10, and c ← c + 1,
21:  else
22:  break.
23:  end if
24:  end for
    (Improve control policy using Sontag's formula)
25: Update the control policy as follows:
        ${ψ}_{k + 2} ( \text{?} ) = \{ \begin{matrix}- \frac{{L}_{F} {V}_{k + 1} + \sqrt{\text{?}}}{\text{?}} {R}^{- 1} {L}_{G} {V}_{k + 1}^{T} & {L}_{G} {\hat{V}}_{k + 1} \neq 0 \\ 0 & {L}_{G} {\hat{V}}_{k + 1} = 0\end{matrix}$
26:  end if
27:  k ← k + 1, l ← l + 1
28:  end for
29: end for [symbol]
indicates data missing or illegible when filed
```

8. The nonlinear optimal control method of claim 7, wherein the approximate safe policy iteration algorithm learns neural network, and the neural network satisfies the property of the control Lyapunov function.

9. The nonlinear optimal control method of claim 7, wherein the approximate safe policy iteration algorithm gathers the states determined by a stabilization control input (\hat{ψ}ₖ) and performs weight update of a value function (\hat{V}ₖ) approximated by a deep neural network in the direction of reducing Bellman errors in a policy evaluation part, constraints are considered through an augmented objective function including the barrier function, and
wherein the approximate safe policy iteration algorithm ensures the constraints satisfaction and stability during and after the learning using the Sontag's formula in a policy improvement part.

10. The nonlinear optimal control method of claim 9, wherein when the weight updated value function does not satisfy the control Lyapunov function conditions, the weight update is performed again to satisfy the function conditions.
